(19) United States
(12) Patent Application Publication
(10) Pub. No.: US 2013/0176300 A1
(43) Pub. Date: Jul. 11, 2013

(54) DISPARITY MAPS IN UNIFORM AREAS

(71) Applicant: Thomson Licensing, Issy de Moulineaux (FR)

(72) Inventors: Philippe Robert, Cesson Sevigne (FR); Valter Drazic, Cesson Sevigne (FR); Pierre-Henri Conze, Cesson Sevigne (FR); Thierry Viellard, Cesson Sevigne (FR)

(73) Assignee: Thomson Licensing, Issy de Moulineaux (FR)

(21) Appl. No.: 13/727,909

(22) Filed: Dec. 27, 2012

(30) Foreign Application Priority Data
Jan. 10, 2012 (FR) 12305030.4

(51) Int. Cl. G06T 15/00

(52) U.S. Cl. CPC G06T 15/00
USPC 345/419

(57) ABSTRACT

The invention concerns a method of processing left and right disparity maps comprising a step of computing a disparity map for each view comprising the step of detecting the uniform areas from the right and left views and filtering the disparity maps taking account of the detected uniform area.

This application claims the benefit of European patent application No. EP12305030.4, filed on Jan. 10, 2012.

### BACKGROUND

The invention concerns a method for processing disparity maps obtained from left and right views of stereovision images in stereovision.

The invention concerns more precisely a method for estimating the disparity in uniform areas.

As there is no gradient to rely on in these uniform areas, the set of possible candidates for matching is often large. Smoothness constraints can advantageously help in avoiding noisy disparity in these areas.

However, it does not mean that disparity is correct.

Moreover, it happens that there is a color difference between the views. It may happen for example if the cameras have not been color-matched in a prior calibration phase. The consequence is that it is difficult to accurately estimate disparity with the classical methods, in particular in the uniform areas. Actually, disparity estimation in such uniform areas is always a problem but it is quite critical when there is color dissimilarity: this is a problem when real disparity is sought, this may be a problem also when disparity is used for interpolation: there is a risk that for example with false disparity values the textureless background occludes a foreground object in an interpolated frame.

Joint estimation of left disparity map with regard to right view and right disparity map with regard to left view is a known method used to add constraint in the estimation process: both disparity maps must be consistent with each other. Consistency checking is often used to detect occlusions. Disparity consistency can also be used as a constraint to make the estimator converge better.

D1 (WO2011104151) discloses A method for generating a confidence map comprising a plurality of confidence values, each being assigned to respective disparity value in a disparity map assigned to at least two stereo images each having a plurality of pixels, wherein a single confidence value is determined for each disparity value, and wherein for determination of the confidence value at least a first confidence value based on a match quality between a pixel or a group of pixels in the first stereo image and a corresponding pixel or a corresponding group of pixels in the second stereo image and a second confidence value based on a consistency of the corresponding disparity estimates is taken into account.

Although this document discloses cross-multilateral filter using confidence maps, it does not deal with the uniform area. A cross bilateral filter also known as joint bilateral filter is a variant of a bilateral filter.

The article “HIERARCHICAL JOINT BILATERAL FILTERING FOR DEPTH POST-PROCESSING” FROM Proceedings of the Sixth International Conference on Image and Graphics (ICIG 2011)|129-34|2011 IEEE Computer society discloses a hierarchical joint bilateral filtering method to improve a coarse depth map. By first carrying out depth confidence measuring, pixels are put into different categories according to their matching confidence. Then the initial coarse depth map is down-sampled together with the corresponding confidence map. Depth map is progressively fixed during multistep up sampling. Different from many filtering approaches, confident matches are propagated to unconfident regions by suppressing outliers in a hierarchical structure. Experiment results present that the proposed method can achieve significant improvement of initial depth map with low computational complexity.

In HD format however, the uniform areas can include thousands pixels and convergence can be difficult to achieve. It is further critical when there is a color difference between the views.

### SUMMARY

Thus it is an object of the invention to provide a method of processing left and right disparity maps obtained from left and right views of stereovision images, disparity vectors linking points of areas in the left view to points of areas in the right view and vice versa. The method comprises a step of computing a disparity map for each view. The method comprises further the step of detecting the uniform areas from the right and left views and of filtering the disparity maps taking account of the detected uniform area.

With the method claimed in claim 1 disparity filtering for filtering left and right disparity maps taking account from uniform areas makes left and right disparity maps smoother and more consistent.

According to an aspect of the present invention, the method comprises further the step of detecting textured areas in each disparity map in which disparity vectors link points of the textured area in the left view to points of textured area in the right view and vice versa; defining a forbidden interval inside the disparity range corresponding to the detected textured area, reducing the disparity range so that disparity vectors of uniform area point outside the forbidden area and filtering the disparity maps taking account of the reduced disparity range.

According to another aspect of the invention detecting the uniform area is based on block based representation of the left and right color images.

According to another aspect of the invention filtering the disparity maps consists in a bilateral filtering.

According to an aspect of the present invention bilateral filtering consists in determining a disparity value d(x) for a determined pixel (x) of the left or right view taking account of disparity value d(y) of pixels (y) belonging to the spatial neighborhood of the determined pixel (x) in a weighted mean according to components of quality.

According to an aspect of the present invention weighted mean depends of color similarity between the determined pixel (x) and pixels (y) belonging to the spatial neighborhood of the determined pixel (x).

According to an aspect of the present invention weighted mean depends of distance between the determined pixel (x) and pixels (y) belonging to the spatial neighborhood of the determined pixel (x).

According to another aspect of the invention weighted mean depends of quality of the disparity value between the determined pixel (x) and pixels (y) belonging to the spatial neighborhood of the determined pixel (x), determined via a machine cost.

According to an aspect of the present invention the disparity filtering consists in a crossbilateral filtering applied to either all pixels or a part of the pixels and iterated several times

According to another aspect of the invention detecting the uniform areas from the right and left views consist in selecting each block for which a luminance variance value between left and right image is under a determined threshold value.

According to another aspect of the invention weighted mean takes account of luminance similarity between the determined pixel (x) and pixels (y) belonging to the spatial neighborhood of the determined pixel (x).

The above-mentioned and other features and advantages of this invention, and the manner of attaining them, will become more apparent and the invention will be better understood by reference to the following description of embodiments of the invention taken in conjunction with the accompanying drawings, wherein:

### BRIEF DESCRIPTION OF THE DRAWINGS

FIG. 1 is a block diagram of a work flow of a method for processing dense disparity map;

FIG. 2 is a block diagram of a work flow of a method for joint sequential bilateral filtering of left and right disparity maps

FIG. 3 is a block diagram of a work flow of a method for processing disparity maps in accordance with an exemplary embodiment of the present invention

FIG. 4 is a block diagram of a work flow of a method for processing disparity maps in accordance with an exemplary embodiment of the present invention

FIG. 5 is a representation of forbidden disparity values due to a textured object in an uniform area;

FIG. 6 is a representation of a reduced disparity range due to a modification of a disparity vector pointing at a forbidden position.

FIG. 7 is a representation of the

The exemplifications set out herein illustrate preferred embodiments of the invention, and such exemplifications are not to be construed as limiting the scope of the invention in any manner.

### DETAILED DESCRIPTION OF PREFERRED EMBODIMENTS

In order to satisfactorily deal with uniform areas in large images as HD format, and with possible color dissimilarity between views, the estimation of disparity is based on hierarchical block-matching. One disparity value is associated to each block.

This is important to process the block-based representation in order to efficiently deal with large textureless areas: the image size is reduced by a factor corresponding to the block size.

The filtering that can be considered as a post-processing can be applied to the dense disparity maps as well as to block-based disparity maps with some small differences.

According to a variant, the filtering can be applied to some particular pixels instead of all the pixels.

According to a variant, post-processing step is applied to block-based disparity maps and limited to uniform areas. In this context, it consists in first detecting the uniform areas or the uniform groups of blocks in the current image from the left and right views or frames and then in filtering the disparity values under smoothness and consistency constraints.

Moreover, an additional constraint is added in order to manage color dissimilarity and prevent occlusion risks.

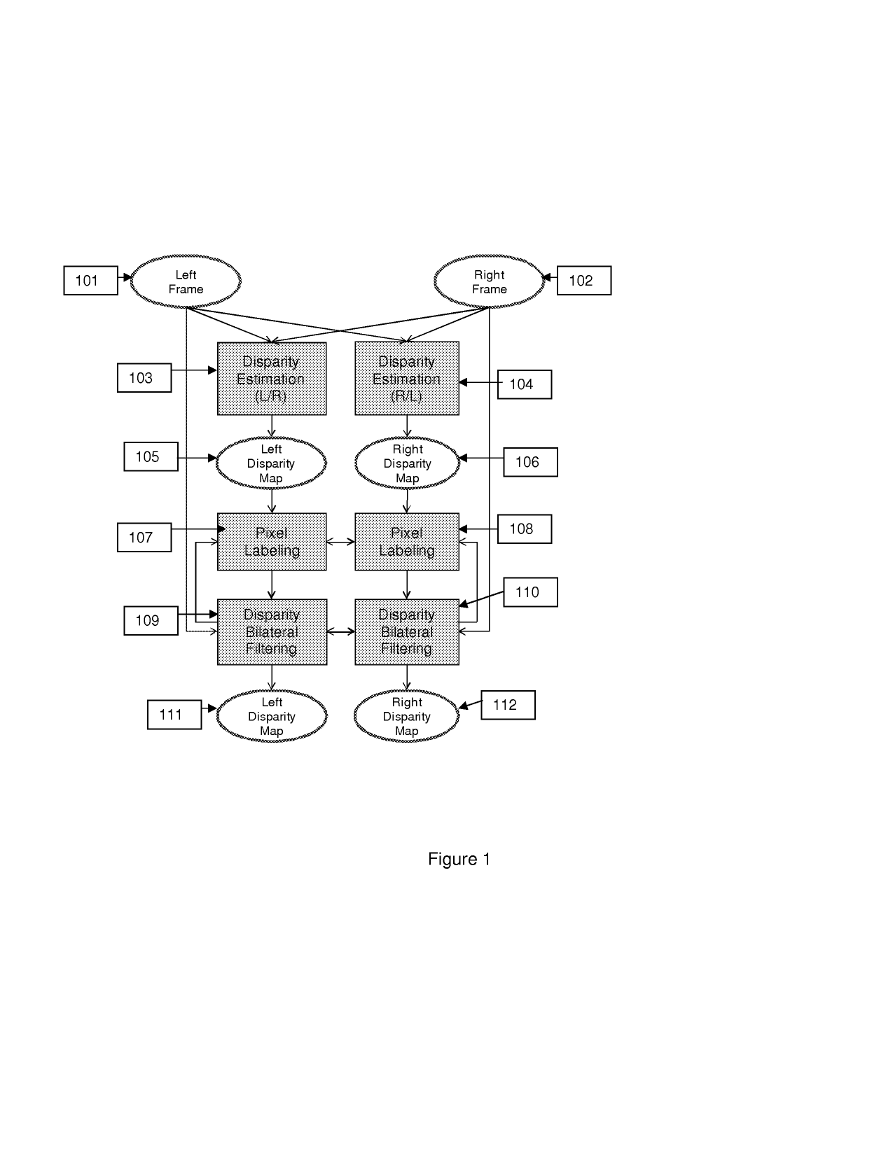

This bilateral filtering is included in a disparity estimation chain as represented by the FIG. 1. A first module computes dense left and right disparity maps 105, 106 for each left and right view 101, 102 following a step of disparity estimation between the pixels of the right view to the pixels of the right view 103 or vice versa 104. Following this estimation, a step of pixel labeling 107, 108 in the dense left and right disparity maps 105, 106 consists in detecting occlusions and inconsistencies. Then, an iterative process called bilateral filtering 109, 110 filters disparity in the inconsistent areas and in the areas occluded in the other view obtaining a left and right improved disparity map 111, 112.

Bilateral filtering 109, 110 as represented in the FIG. 1 is an efficient solution to reduce noise in an image. It has been already used to smooth disparity maps. This is a weighted mean of disparity values taken in the neighborhood of the current pixel. The equation is the following:

$$\hat{d} ( x ) = \frac{{\sum }_{y} {W}_{xy} \times d ( y )}{{\sum }_{y} {W}_{xy}}$$

Where x is the pixel with disparity d(x) which is filtered, y corresponds to the pixels in the spatial neighborhood that contribute via their disparity value d(y) to the filtering of x. Wxy weights d(y) according to color similarity between x and y, distance between x and y.

The sums of the weighting parameters of pixels y so as the sum of the product of this weighting parameter by the disparity value of pixels y are computed on a window centered on current pixel. It can be for example a 21×21 square window.

Many solutions are possible for the weight W_{xy}, for example:

W_{xy}=e^{-δ}^{^{−1}}^{Δ}^{_{wy}}^{²}^{-γ}^{^{−1}}^{Γ}^{_{xy}}^{²}

With the following components:
Δ_{xy} takes into account the color similarity between pixels x and y:

$${Δ}_{xy} = {\sum }_{c ∈ \{ r , g , b \}} \vert {I}_{c} ( y ) - {I}_{c} ( x ) \vert$$

δ_{xy} takes into account the distance between pixels x and y:

Γ_{xy}=∥x−y∥₂
δ and γ are weights applied to Δ and Γ.

For the invention another component to the weight above that takes into account the quality of the disparity value via a matching cost are added:

W_{xy}=e^{-δ}^{^{−1}}^{Δ}^{_{wy}}^{²}^{-γ}^{^{−1}}^{Γ}^{_{xy}}^{²}^{-β}^{^{−1}}^{D}^{_{y}}^{²}

D refers to the matching cost, for example:

$$D ( y , {d}_{y} ) = {\sum }_{c ∈ \{ r , g , b \}} \vert {I}_{c}^{K} ( y ) - {I}_{c}^{J} ( y - {d}_{y} ) \vert$$

Ic is a color component, K and J refer respectively to left/right and right/left views.

In addition, in order to impose consistency between left and right disparity maps, both disparity maps are taken into account in the filtering equation:

$${\hat{d}}_{L} ( x ) = \frac{{\sum }_{y} ( {W}_{xy} \times {d}_{L} ( y ) ) + {\sum }_{y} ( {W}_{xy} \times {d}_{R} ( y - {d}_{L} ( x ) ) )}{{\sum }_{y} {W}_{xy}}$$

d_{L} and d_{R} are disparity values respectively in left and right views.

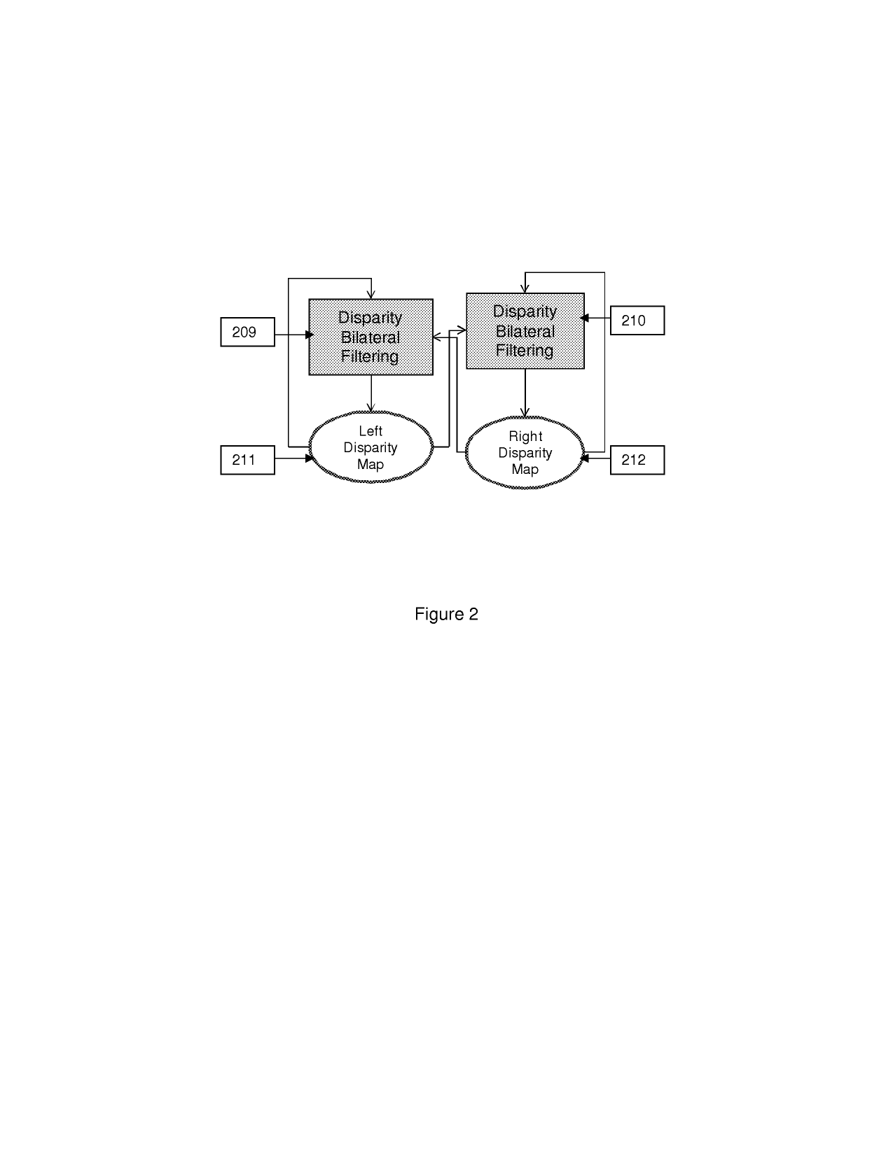

Both left and right disparity maps 211, 212 are further alternatively filtered via cross bilateral filtering 209, 210 as represented by the FIG. 2. Joint sequential bilateral filtering of the left and right disparity maps relies on both left and right disparity maps filtered at the previous iteration. Starting from first maps obtained via a prior estimation, the filtering process can be iterated several times.

The filtering is not necessarily applied to all pixels but only to those ones which disparity vector is detected as inconsistent with the corresponding vector in the other view. Inconsistent disparity vectors are those ones which inconsistency distance is above a threshold.

Inconsistency is measured as the sum of a first disparity vector dⱼ(x) assigned to the pixel x in view J and a second disparity vector in the other view K located at the point y the first vector points to.

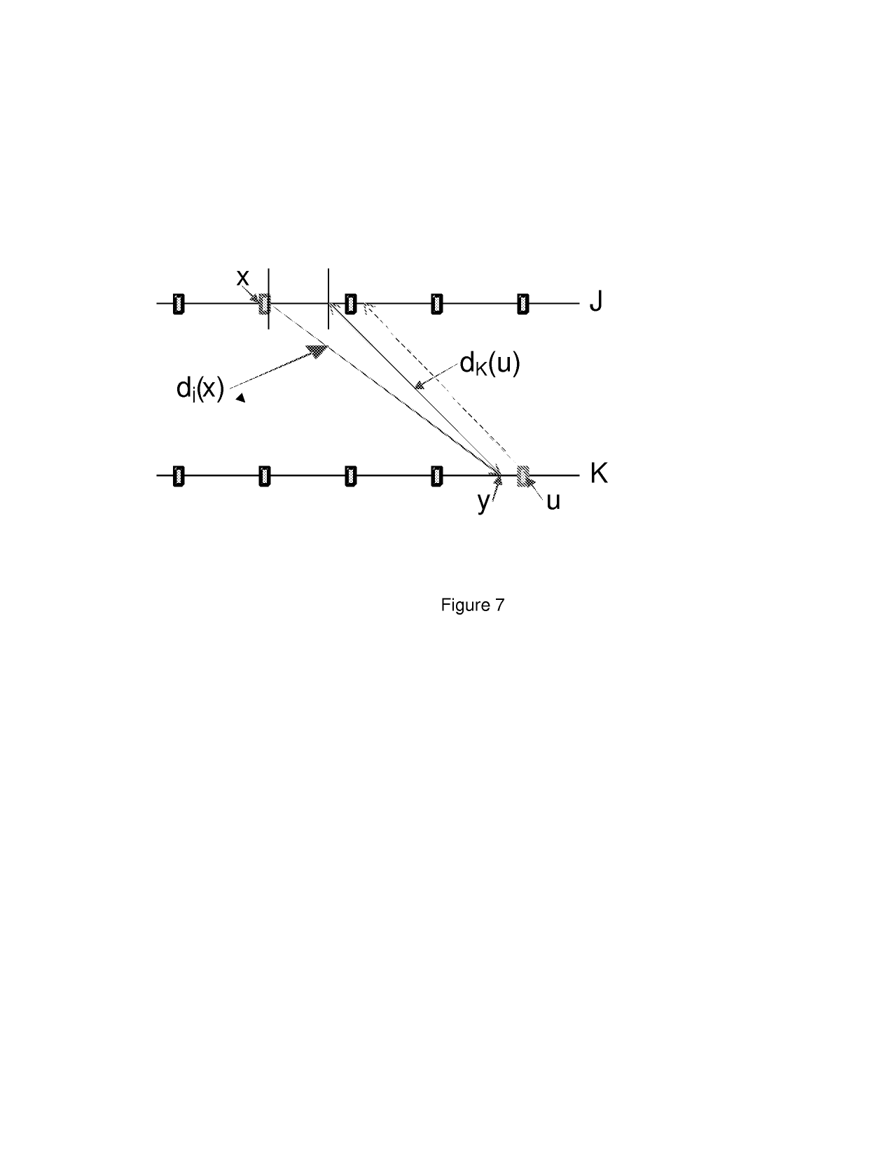

The second vector can be obtained by bilinear interpolation from the disparity vectors of the 4 surrounding pixels. Or it can be simply obtained from the vector dₖ(u) of the closes pixel u as shown in FIG. 7. If the two vectors are perfectly consistent, the sum is 0. Otherwise, the inconsistency value is thresholded in order to classify pixel vectors into “consistent” or “inconsistent”.

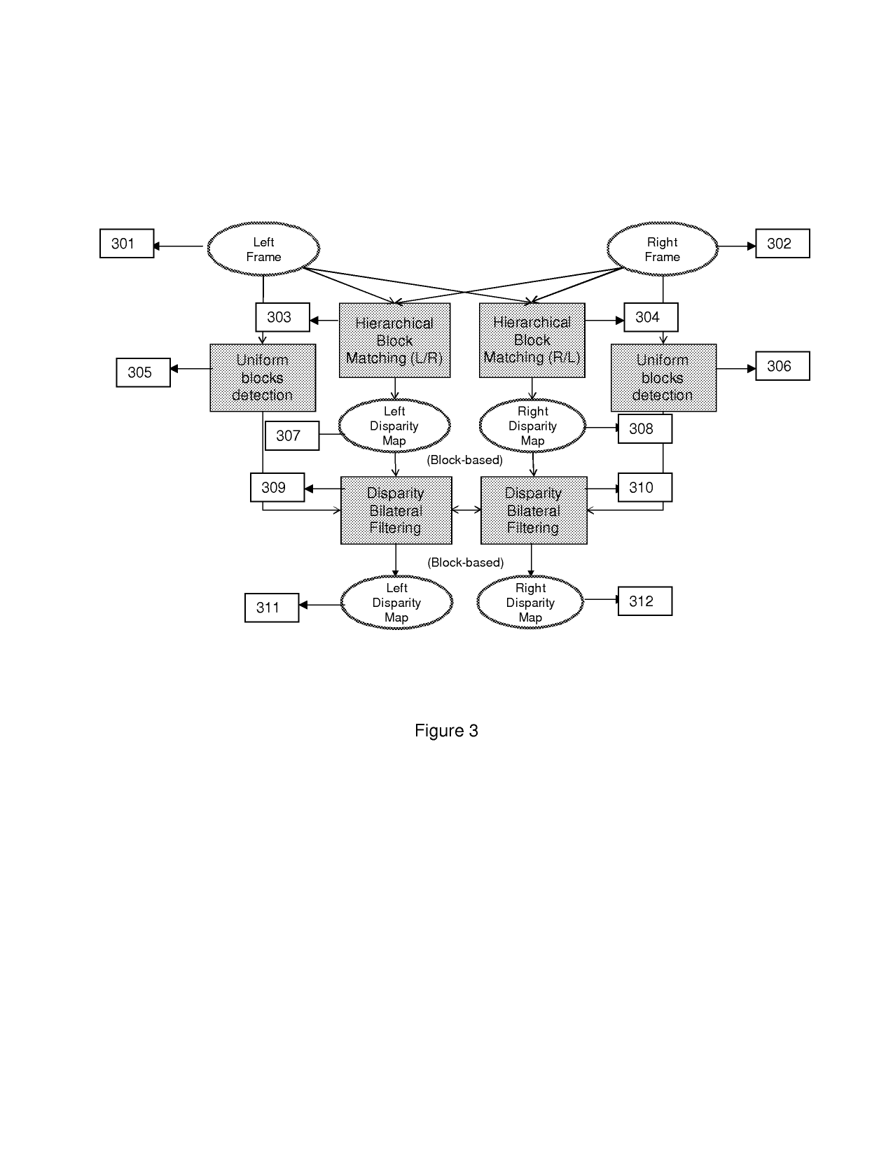

FIG. 3 corresponds to the block-based variant and depicts the block-based disparity estimation with two hierarchical block matching 303, 304 respectively for left/right view with regard to right/left view 301, 302. left and right disparity maps 307 308, for each left and right view are thus computed

The main steps of disparity estimation processing that smoothes and improves the consistency of left and right disparity maps are represented by the FIG. 3 in which hierarchical block matching 303, 304 are processed from left frame 301 to right frame 302 or from right to left frames. Left and right views are represented respectively by frames of pixels. Left disparity map 307 so as right disparity map 308 are issued respectively from left to right and right to left block matching.

Uniform areas 305, 306 from the left frame and from the right frame are then detected Taking account of the detected uniform blocks a disparity bilateral filtering 309, 310 is applied to each of the left and right disparity maps creating an improved left and right disparity maps 311, 312

Disparity bilateral filtering filters in the uniform areas under smoothness and consistency constraints. The bilateral filtering is applied to the disparity maps with improvements in particular in order to make left and right disparity maps more consistent.

Relying on the block structure used for block-matching, another module 305, 306 consists in detecting the blocks that belong to a uniform area.

A particular solution is for example based on centered variance computed for each block. Each block with a luminance variance value under a threshold is selected. Considering the immediate neighborhood of such selected block, if the number of blocks with a luminance value similar to the current one, the absolute difference being under a threshold value, is significant, then the current block is classified as “uniform”. With “significant, it means above a threshold value.

Then filtering is applied after the hierarchical block matching on the uniform areas. The disparity filtering block 309, 310 is based on consistency-constraining bilateral filtering described before. In the present case, it is applied to the block-based disparity representation. A possible implementation is the following: each block has a disparity vector and is represented by its luminance mean value I_{B}. The previous filtering equation that forces consistency can be applied:

$${\hat{d}}_{L} ( x ) = \frac{{\sum }_{y} ( {W}_{xy} \times {d}_{L} ( y ) ) + {\sum }_{y} ( {W}_{xy} \times {d}_{R} ( y - {d}_{L} ( x ) ) )}{{\sum }_{y} {W}_{xy}}$$

The component Δ_{xy} can be modified to take into account the luminance similarity between blocks x and y:

Δ_{xy}=|I_{B}(y)−I_{B}(x)|

In another working mode, it can be applied to all the blocks of the disparity map. It can also be applied at each level of the hierarchical block matching on the current disparity map before its use in the next finer level. Improved left/right disparity maps 311,312 are then created.

Alternatively, joint sequential bilateral filtering as described with the FIG. 2 is applied after the hierarchical block matching on the uniform area.

The management of the uniform areas around the thin objects and of the risk of occlusion is parts of a post processing of the invention.

As described before, detection of the uniform areas is processed.

A further step consists in the limitation of the disparity range in these areas constrained by the textured areas. Then disparity bilateral filtering in these areas is applied to the disparity maps under smoothness, range and consistency constraints.

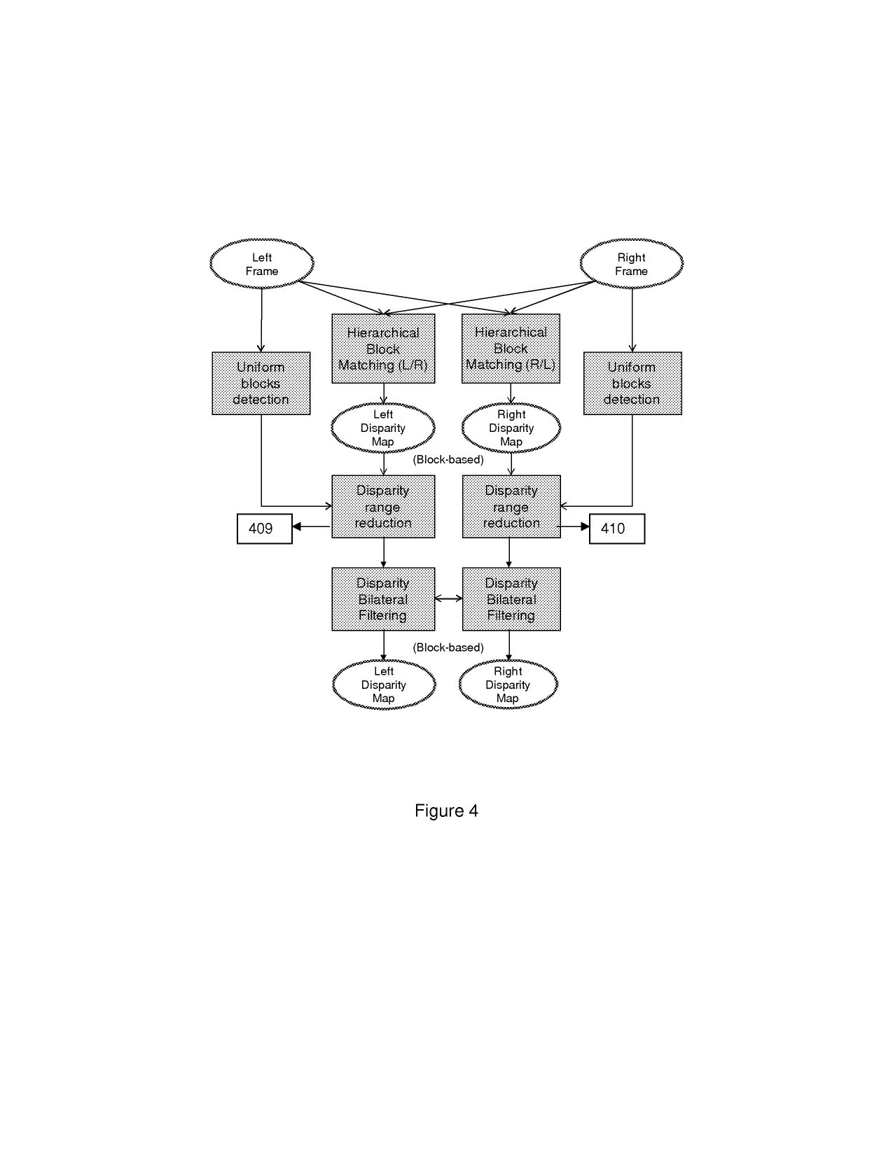

The scheme is depicted in FIG. 4. Step 1 consisting in the detection of the uniform areas has already been presented.

Step 2 is now described. It corresponds to the disparity range reduction step 409, 410 or limitation of the disparity range in the areas constrained by the textured areas

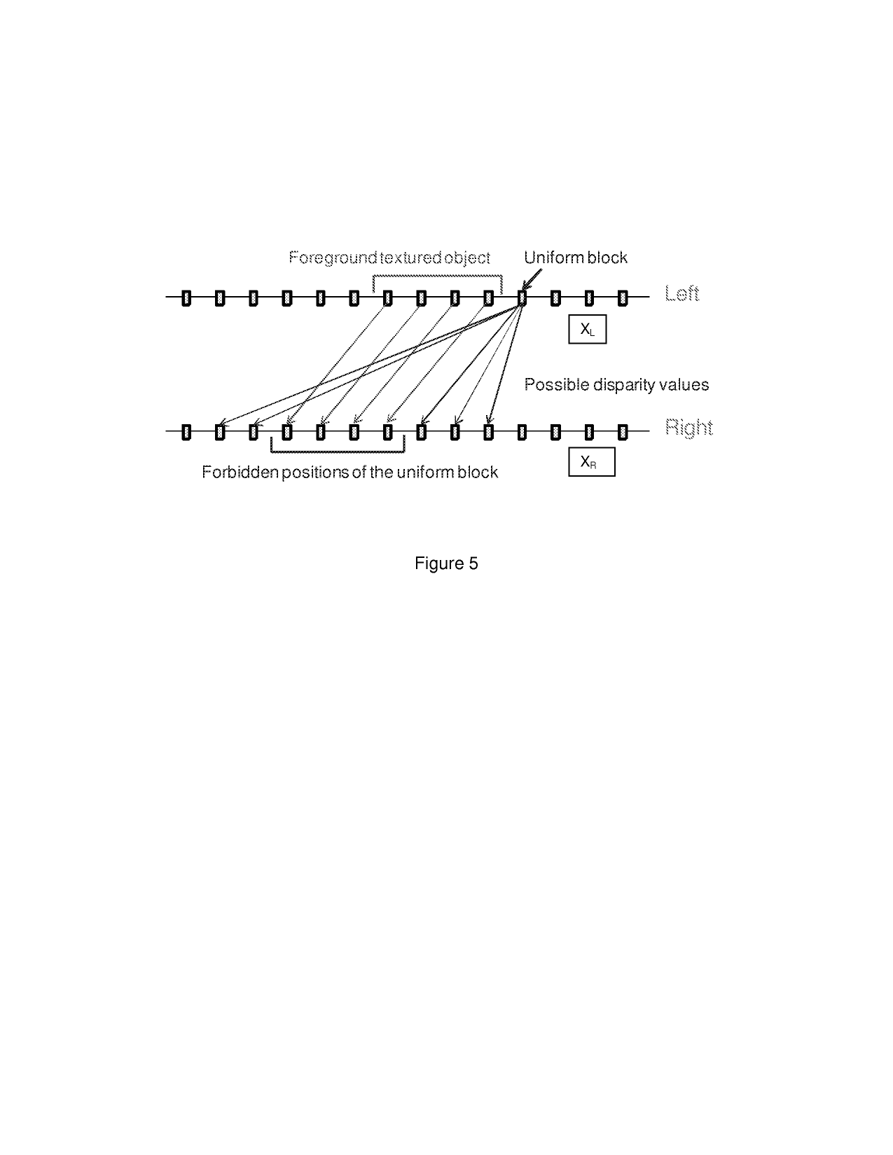

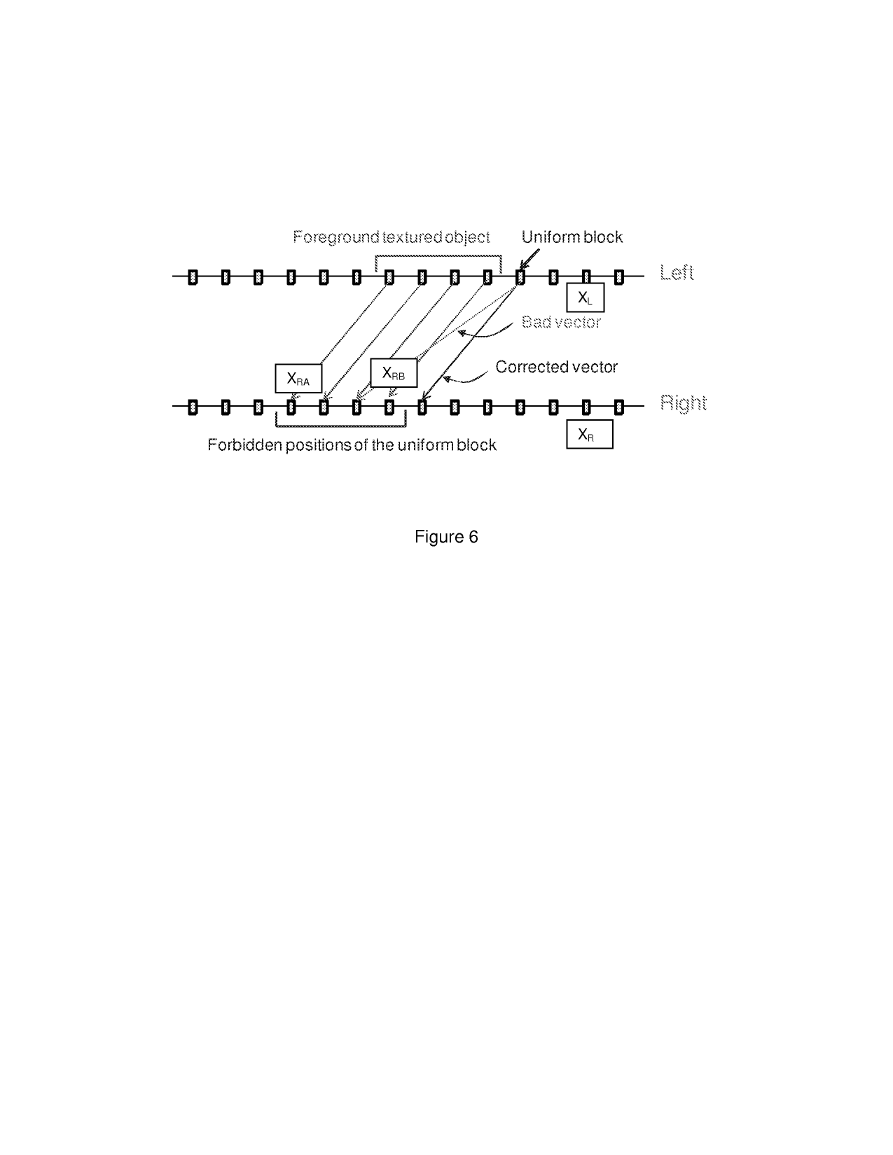

FIG. 5 and FIG. 6 illustrate the problem. It shows a set of disparity vectors linking points of a textured area in the left view to points in the right view. The blocks are reduced to a point representation in the FIG. 5 and in the FIG. 6. It is assumed that these points are visible on both views, so they have a small matching cost.

Note that the disparity value of pixel or block x_{L} in the left image is defined as:

disp(x_{L})=x_{L}−x_{R}

where x_{L} and x_{R} are respectively the abscissa of the current point and of the corresponding point in the right image. Disparity vectors links the pixels x_{L} to x_{R}.

Let us consider now blocks represented in the FIG. 5 and FIG. 6 by points in a uniform area on the right side of this set of textured area points. If such points have a larger disparity value, it means that they are closer to the camera than the textured object. It is represented by two disparity vectors pointing to pixels on the left side of the pixels representing the textured area of the right view. However they should not occlude it as the textured object is visible in both views. Therefore, the position of the uniform blocks in the right view cannot fit the one of a foreground textured object. Consequently, and as represented in the FIG. 6, there is a forbidden interval inside the initial disparity range of the uniform block. There are several ways to define the forbidden interval. One of them can be first to identify the interval [x_{RA}, x_{RB}] corresponding to the left and right position bounds of the textured object in the right image. Then, the forbidden interval of the uniform block at abscissa x_{L} on the right side of the foreground object is [x_{L}−x_{RA}, x_{L}−x_{RB}].

So, processing of the left disparity map is the following at each line scanned from left to right:
1. Scan the line and stop when the current block x_{L} belongs to a textured foreground object (this is not a uniform block and the cost matching is below a threshold). Compute its position in right view: x_{RA}=x_{LA}−disp(x_{LA});
2. Determine the last consecutive textured foreground block x_{LB} and compute its position x_{RB} in right view: x_{RB}=x_{LB}−disp(x_{LB});
3. Compute the forbidden disparity interval I_{F}(x_{L}) [x_{L}−x_{RA}, x_{L}−x_{RB}] of the current block x_{L};
4. Compare I_{F}(x_{L}) with the disparity range [dmin,dmax]; if I_{F}(x_{L}) is out of the disparity range go to 1; otherwise store the forbidden disparity interval I_{F}(x_{L}) and consider the next block and go to 3.

Processing the right disparity map is similar except that the image is scanned from right to left and the uniform blocks located on the left side of a foreground textured object are considered.

Then, the disparity vectors that point at forbidden positions are modified. They are modified so that they point at outside the forbidden area and do not span it. This modification is introduced to really avoid occlusion of objects, in particular thin objects, by uniform areas. This occlusion risk exists especially when the images are much noisy or if there is a color mismatch between left and right images that disrupt the disparity estimator.

So, referring to the previous notation, if the forbidden interval I_{F}(x_{L}) of the current block x_{L} is defined by [x_{L}−x_{RA}, x_{L}−x_{RB}], and if the estimated disparity vector points at inside this interval, the vector is forced at (FIG. 6):

disp(x_{L})=x_{L}−x_{RA}−1

The consistency-constraining bilateral filtering is applied as before to the uniform areas:

$${\hat{d}}_{L} ( x ) = \frac{{\sum }_{y} {W}_{xy} \times {d}_{L} ( y ) + {\sum }_{y} {W}_{xy} \times {d}_{R} ( y - {d}_{L} ( x ) )}{{\sum }_{y} {W}_{xy}}$$

In this new context, some disparity vectors have been modified in the previous step.

In order to take advantage of the disparity vector correction, disparity confidence is thus introduced in the filtering. So, a confidence map is first computed with a confidence value at least for the block disparity values that are used in the filtering process. Therefore, the weight W_{xy} includes now a confidence value:

W_{xy}=conf(d_{y})×e^{-δ}^{^{−1}}^{Δ}^{_{xy}}^{²}^{-γ}^{^{−1}}^{Γ}^{_{xy}}^{²}^{-β}^{^{−1}}^{D}^{_{y}}^{²}

The confidence is defined so that it increases the weight of the constrained vectors that are outside the forbidden interval, for example:
Vector of a uniform area
   There is a forbidden interval and the vector points at outside the interval (corrected or unchanged):
      It has a small matching cost (below a threshold): high confidence
      The matching cost is equal to or over the threshold: low confidence
   There is no forbidden interval (the vector is not constrained by the presence of a textured object): low confidence
Vector of a textured area (not a uniform one): high confidence

In addition, the confidence value as above defined can be adjusted by the matching cost, e.g. by deducting a normalized matching cost value from it.

As already said, there can be color mismatch between left and right views and in such cases, robust matching costs must be used. Correlation is such an operator. For example, if we consider a luminance affine transformation between two blocks Y and X in respectively the left and right views:

Yᵢ=a×Xᵢ+b

Then,

$$R = \sqrt{a \cdot {a}^{′}} = \frac{{var}_{C} [ X , Y ]}{\sqrt{{var}_{C} [ X ] {var}_{C} [ Y ]}}$$

is a robust estimator (var_{C} is the centered variance). Correlation is used as the matching cost in the hierarchical block matching. In addition, the estimator computes the gain a as follows:

$$a = \frac{{var}_{C} [ X , Y ]}{{var}_{C} [ X ]}$$

We consider that in case of luminance mismatch between views, the gain should be included in an interval, for example [0.5; 2]. Actually, we consider that a gain value outside this interval is not realistic (it does not correspond to a luminance mismatch between views). It means that if the gain is outside this interval, the corresponding disparity candidate must be penalized. So, when considering a disparity candidate, the gain and correlation are computed. A possible way to take into account the constraint on the gain is for example to set the correlation at 0 when the gain is outside the interval, before comparison of the correlation values.

1. A method of processing left and right disparity maps obtained from left and right views of stereovision images, comprising a step of computing a disparity map for each view,
wherein the method comprises the step of
detecting at least one uniform areas from the right and left views and filtering the disparity maps taking account of the detected uniform area.

2. Method of processing as claimed in claim 1, disparity vectors linking points of areas in the left view to points in the right view and vice versa comprising further the step of
detecting textured areas in each disparity map in which disparity vectors link points of the textured area in the left view to points of textured area in the right view and vice versa;
defining a forbidden interval inside the disparity range corresponding to the detected textured area;
Reducing the disparity range so that disparity vectors of uniform area point outside the forbidden area;
and filtering the disparity maps taking account of the reduce disparity range.

3. Method of processing as claimed in claim 1 wherein detecting the uniform area is based on block based representation of the left and right color images.

4. Method of processing as claimed in claim 1 wherein filtering the disparity maps consists in a bilateral filtering.

5. Method of processing as claimed in claim 4 wherein bilateral filtering consists in determining a disparity value for a determined pixel of the left or right view taking account of disparity value of pixels belonging to the spatial neighborhood of the determined pixel in a weighted mean according to components of quality.

6. Method of processing as claimed in claim 5 wherein weighted mean depends of color similarity between the determined pixel and pixels belonging to the spatial neighborhood of the determined pixel.

7. Method of processing as claimed in claim 5 wherein weighted mean W_{xy} depends of distance between the determined pixel and pixels belonging to the spatial neighborhood of the determined pixel.

8. Method of processing as claimed in claim 5 wherein weighted mean depends of quality of the disparity value between the determined pixel and pixels belonging to the spatial neighborhood of the determined pixel, determined via a machine cost.

9. Method of processing as claimed in claim 5 wherein weighted means includes a confidence value indicating detected uniform area or textured area.

10. Method of processing as claimed in claim 4 in which the disparity filtering consists in a crossbilateral filtering applied to either all pixels or a part of the pixels and iterated several times.

11. Method of processing as claimed in claim 3 in which detecting the uniform areas from the right and left views consist in selecting each block for which a luminance variance value between left and right image is under a determined threshold value.

12. Method of disparity estimation as claimed in claim 5 wherein weighted mean takes account of luminance similarity between the determined pixel and pixels belonging to the spatial neighborhood of the determined pixel.
